(19) United States
(12) Patent Application Publication
(10) Pub. No.: US 2020/0386324 A1
(43) Pub. Date: Dec. 10, 2020

(54) BALL VALVE WITH CRYOGENIC SEAT

(71) Applicant: BAC VALVES, S.A., FIGUERAS (GIRONA) (ES)

(72) Inventors: Carles BACH CANTENYS, FIGUERAS (GIRONA) (ES); Eduard TURON TEIXIDOR, FIGUERAS (GIRONA) (ES); Tomas PARADINAS SALSON, FIGUERAS (GIRONA) (ES)

(21) Appl. No.: 16/474,679

(22) PCT Filed: Dec. 27, 2017
(86) PCT No.: PCT/ES2017/070854

§ 371 Date: Jun. 28, 2019

(30) Foreign Application Priority Data
Dec. 28, 2016 (EP) 16380039.4

(51) Int. Cl. F16K 5/06

(52) U.S. Cl. CPC F16K 5/0678; F16K 5/0689

(57) ABSTRACT

The invention relates to a ball valve with a cryogenic seat, which has a valve body with inlet and outlet ducts, a ball with a through hole arranged in an inner recess of the valve body between the inlet and outlet ducts, a closing seat for each duct having a sealing gasket that has a first portion which is inserted into a housing defined in the wall of the inner recess wherein the ball is arranged and a second portion which protrudes from the housing and is in contact with the ball, and a pressure element which pushes the sealing gasket against the ball, wherein the pressure element is arranged in the housing of the wall of the inner recess wherein the ball is arranged, in contact with the first portion of the sealing gasket.

### TECHNICAL FIELD

The present invention relates to ball valves used in conduits carrying fluids, proposing a valve with a cryogenic seat made with features which enable perfect closure conditions to be effectively obtained in any condition of use of the valves of application, even at cryogenic temperatures.

### STATE OF THE ART

Ball valves are commonly used in conduits carrying fluids, comprising a ball provided with a through hole therethrough and which is snugly arranged in a corresponding spherically concave inner recess defined between an inlet duct and an outlet duct of the valve, such that by means of the rotation of the ball it is possible to interrupt and establish the passage between said inlet and outlet ducts of the valve.

In order for a totally airtight seal to be established between the ball and the wall of the inner recess wherein it is arranged, which ensures the perfect functioning of the valve, the convex surface of the ball must coincide exactly with the concave surface of the inner recess, conventionally being arranged around the inner mouth of each of the inlet and outlet ducts of the valve, between the wall of the inner recess wherein the ball is arranged and the outer ball surface, a closing seat made up of a sealing gasket made of elastic material, in order to achieve an adaptation to possible irregularities of the shape of the ball and thus prevent leaks from the valves.

However, at very low temperatures the elastic materials of the gaskets harden and lose the elasticity necessary to adapt to the irregularities of the ball of the valves, while at said low temperatures the balls can become deformed and become oval-shaped or irregular, due to the fact that the contraction of the metal material thereof is not linear.

Therefore, in applications with cryogenic temperatures (between −29° C. and −196° C.) of conventional ball valves, the closing seats between the rotating ball and the wall of the corresponding inner recess lose their airtight seal, producing leaks, for which reason said valves are not efficient at those temperatures.

The document ES2549277B1 of the same applicant as the present invention shows a ball valve with a closing seat having a sealing gasket and a spring. The sealing gasket has a first portion which is inserted into a housing of the wall of the inner recess wherein the ball is arranged and a second portion which protrudes from said housing and is in contact with the ball. The spring is located between the wall of the inner recess wherein the ball and the second portion of the sealing gasket are arranged, such that the spring pushes the second portion of the sealing gasket against the surface of the ball establishing an airtight closing.

This closing seat in normal conditions maintains the airtightness between the ball and the wall of the inner recess wherein the ball is arranged, and in conditions with cryogenic temperatures wherein the sealing gasket loses elasticity and the ball can become deformed due to uneven contraction in the mass thereof, the push of the spring on the sealing gasket makes the gasket adapt to the surface of the ball, ensuring an airtight closing.

Now, although this solution ensures contact between the second portion of the sealing gasket and the ball, the applicant has found that at cryogenic temperatures the fluid passing through the through hole of the ball leaks through the housing wherein the first portion of the sealing gasket is inserted.

A solution is therefore necessary which enables leaks to be prevented which occur through the housing wherein the sealing gasket is inserted.

### OBJECT OF THE INVENTION

The invention relates to a ball valve with a cryogenic seat which makes it possible to ensure the airtightness of the valve even in conditions with cryogenic temperatures.

The ball valve comprises:
a valve body with inlet and outlet ducts,
a ball with a through hole which is arranged in an inner recess of the valve body between the inlet and outlet ducts, the ball being able to rotate between a position connecting the through hole to the inlet and outlet ducts and a position wherein it interrupts the passage between said inlet and outlet ducts, and
a closing seat for each inlet and outlet duct comprising:
   a sealing gasket having a first portion which is inserted into a housing defined in the wall of the inner recess wherein the ball is arranged and a second portion which protrudes from the housing and is in contact with the ball, and
   a pressure element which pushes the sealing gasket against the ball, wherein the pressure element is arranged in the housing of the wall of the inner recess wherein the ball is arranged in contact with the first portion of the sealing gasket.

The arrangement of the pressure element in the housing enables a space to be created so that the fluid which can leak from inside the valve is retained in the housing of the sealing gasket, such that the very expansion force of the fluid is used to compress the sealing gasket in the housing and at the same time improve the pressure of the sealing gasket on the ball, thus preventing leaks through the housing of the sealing gasket and ensuring an airtight seal between the ball and the sealing gasket, even in conditions with very low temperatures wherein the sealing gasket loses elasticity. Moreover, the very expansion force of the fluid helps to compress the pressure element and improve the pressure function thereof on the sealing gasket.

Preferably, the first portion of the sealing gasket has an annular lip which is retained in the housing by the pressure exerted by the pressure element. With this arrangement, the seal of the housing of the sealing gasket is improved, further preventing fluid from leaking.

Preferably, the pressure element is a hollow toroidal spring. The hollow embodiment of the pressure element enables the fluid entering the housing to freely expand inside the housing, thereby increasing the contact surface between the fluid and the sealing gasket.

Additionally, the valve comprises a channel which connects the inner recess of the valve to the housing. In this manner, a connection is purposely defined to direct the fluid to the portion of the housing wherein the pressure element is arranged, ensuring that the very pressure of the fluid is used to improve both the airtight seal of the housing and the airtight seal between the sealing gasket and the ball.

In this manner, a ball valve with a closing seat is achieved which is effectively airtight both when the sealing gasket has the necessary elasticity to adapt to the surface of the ball and when, due to the effect of low temperatures, it loses elasticity, since the push from the pressure element provides the necessary pressure so that said sealing gasket may adapt with pressure on the surface of the ball, although it may have some deformation, and at the same time it takes advantage of the expansion force of the fluid which leaks out into the housing of the sealing gasket in order to improve the airtight seal of the closing seat.

### DESCRIPTION OF THE FIGURES

FIG. 1 shows a partial cross-sectional view of the closing seat of a ball valve according to the state of the art.

FIG. 2 shows a perspective view of a partial cross section of the ball valve of the invention.

FIG. 3 is a complete longitudinal cross-sectional view of the valve of the previous figure.

FIG. 4 is an enlarged detailed view of the closing seat of the ball valve invention, according to a first embodiment.

FIG. 4A shows a perspective view of the sealing gasket of the closing seat of the previous figure.

FIG. 5 is an enlarged detailed view of the closing seat of the ball valve invention, according to a second embodiment.

FIG. 5A shows a perspective view of the sealing gasket of the closing seat of the previous figure.

FIG. 6 is an enlarged detailed view of the closing seat of the ball valve invention, according to a third embodiment.

FIG. 6A shows a perspective view of the sealing gasket of the closing seat of the previous figure.

### DETAILED DESCRIPTION OF THE INVENTION

The invention relates to a ball valve of the kind arranged in conduits carrying fluids, particularly for applications in cryogenic temperature conditions, in the order of temperatures between −29° C. and −196° C.

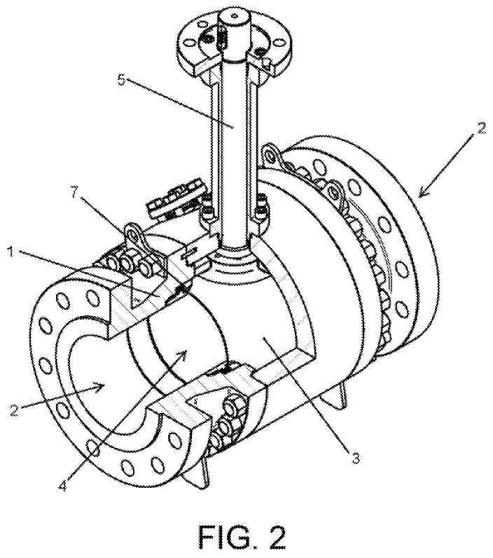

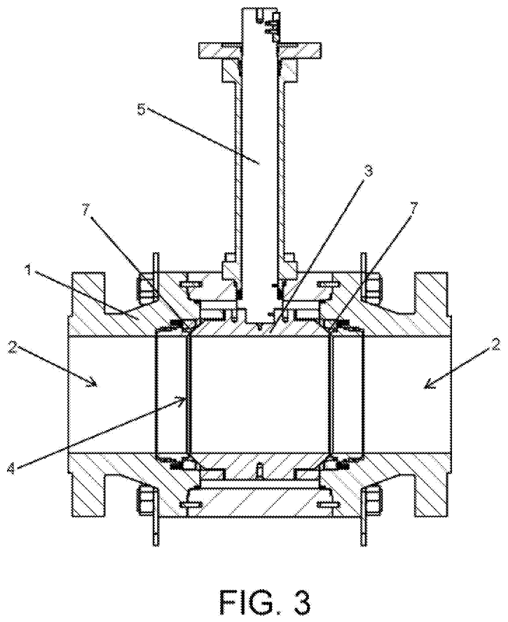

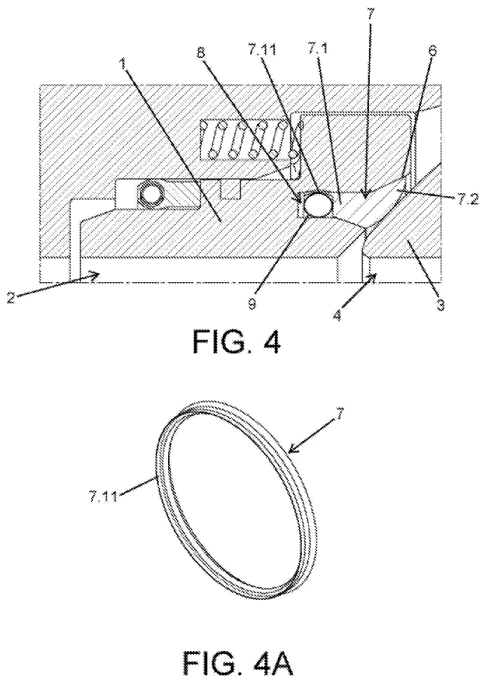

FIGS. 2 and 3 show a ball valve according to the invention comprising a valve body (1) having an inner recess with a spherical configuration with which they connect corresponding opposite ducts (2), one being an inlet and the other an outlet of the passage through the valve, a ball (3) having a through hole (4) and which is joined to a control rod (5) being housed in the inner recess. By means of the rod (5), the ball (3) can rotate between a position wherein the through hole (4) establishes a connection between the inlet and outlet ducts (2) of the valve body (1), leaving the passage open to through the valve, and another position wherein the ball (3) interrupts the connection between said inlet and outlet ducts (2) of the valve body (1), leaving the passage through the valve closed.

The valve comprises a cryogenic seat having a closing seat for each inlet and outlet duct (2) of the valve in order to achieve an airtight seal between the ball (3) and the wall (6) of the inner recess wherein the ball (3) is arranged. The closing seat is arranged around the inner mouth of each of the inlet and outlet ducts (2) of the valve, and comprises a sealing gasket (7) made of elastic material having a first portion (7.1) which is inserted into a housing (8) of the wall (6) of the inner recess wherein the ball (3) and a second portion (7.2) protruding from the housing (8) are arranged and is in contact with the ball (3), and a pressure element (9) which pushes the sealing gasket (7) against the ball (3).

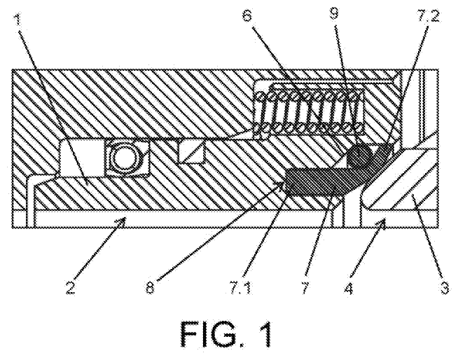

FIG. 1 shows a closing seat made according to the prior state of the art. The first portion (7.1) of the sealing gasket (7) is inserted into the housing (8) of the wall (6) of the inner recess wherein the ball (3) is arranged, while the second portion (7.2) of the sealing gasket (7) protrudes from the housing (8) in contact with the ball (3), in that arrangement the pressure element (9) is located between the wall (6) of the inner recess wherein the ball (3) and the second portion (7.2) of the sealing gasket (7) are arranged, such that the pressure element (9) pushes the second portion (7.2) of the sealing gasket (7) against the surface of the ball (3). In this manner, an airtight seal is ensured due to the fact that the second portion (7.2) of the sealing gasket (7) is pressed on the surface of the ball (3) by the action of the pressure element (9); however, at low cryogenic temperatures the fluid tends to leak from the inner recess through the housing (8) wherein the first portion (7.1) of the sealing gasket (7) is inserted.

The invention proposes solving this problem by arranging the pressure element (9) in the housing (8) of the wall (6) of the inner recess wherein the ball (3) is arranged, the pressure element (9) being in contact with the first portion (7.1) of the sealing gasket (7). With this arrangement, the housing (8) is not completely covered by the first portion (7.1) of the sealing gasket (7), but rather part of the housing (8) is occupied by the pressure element (9), such that the fluid leaking from inside the valve tends to occupy the space of the housing (8) wherein the pressure element (9) is located, the fluid being retained in said space. The fluid due to the very pressure thereof compresses the sealing gasket (7) in the housing (8) pushing it against the ball (3), which helps prevent fluid from escaping the housing (8) and the sealing gasket (7) from pressing against the ball (3). At the same time, the pressure of the fluid helps the pressure element (9) exert force on the sealing gasket (7) and thus put more pressure on the ball (3).

According to a preferred embodiment of the invention, the first portion (7.1) of the sealing gasket (7) has an annular lip (7.11) which is retained in the housing (8) by the pressure exerted by the pressure element (9). The annular lip (7.11) is arranged on the outside of the sealing gasket (7) such that it is retained between the pressure element (9) and the upper wall of the housing (8), while the fluid leaking from the inside of the valve tends to enter the housing (8) from the lower portion thereof. In this manner, the pressure of the fluid helps the pressure element (9) to tighten the annular lip (7.11) of the sealing gasket (7), thereby improving the seal preventing the fluid from escaping the housing (8), even at cryogenic temperatures wherein the sealing gasket (7) loses elasticity.

Preferably, the pressure element (9) is a hollow toroidal spring, meaning an annular helical spring, such that by being a hollow element it enables the fluid to flood the housing (8) and exert a suitable pressure which helps press the sealing gasket (7) against the ball (3), as well as press the annular lip (7.11) against the upper wall of the housing (9).

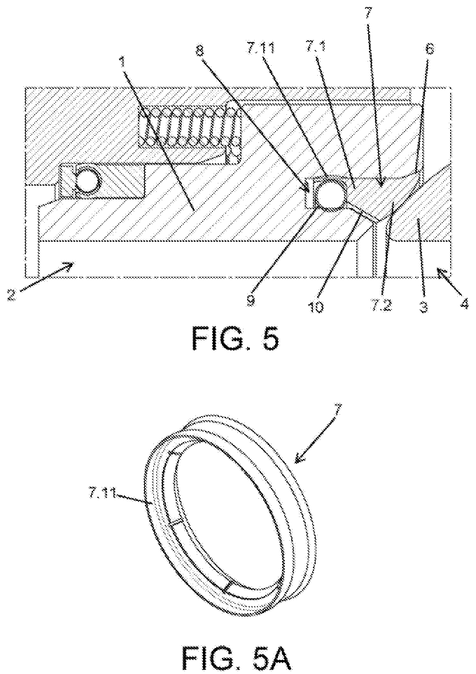

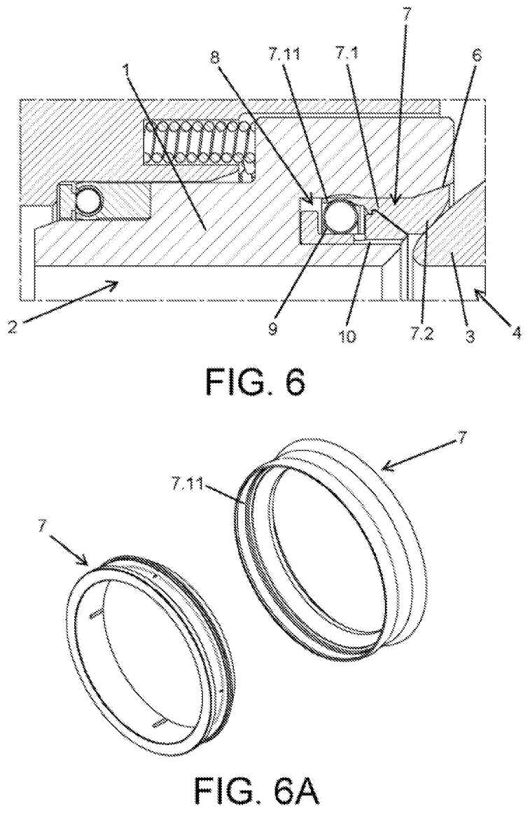

As seen in the exemplary embodiments of FIGS. 5 and 6, it is foreseen that the valve additionally comprises a channel (10) which connects the inner recess wherein the ball (3) is arranged to the housing (8). In this manner a connection is established which ensures that the fluid enters the housing (8), ensuring that the pressure of the very fluid is used to improve the sealing properties of the valve even at cryogenic temperatures.

In small valves and being applicable to conduits carrying fluids at low pressure, the securing of the assembly of the sealing gasket (7) can be established by a simple grip on one of the edges thereof, as in the example of FIGS. 5 and 5A, thereby facilitating the valve assembly. However, in large valves and being applicable to conduits carrying fluids at high pressure, the securing of the assembly of the sealing gasket (7) comprises two annular portions, as seen in the example of FIGS. 6 and 6A, with which a greater resistance to the pressure of the fluids is achieved in effective conditions for an airtight sealing of the valve.

1. A ball valve with a cryogenic seat, which comprises:
a valve body with inlet and outlet ducts,
a ball with a through hole which is arranged in an inner recess of the valve body between the inlet and outlet ducts, the ball being able to rotate between a position connecting the through hole to the inlet and outlet ducts and a position wherein it interrupts the passage between said inlet and outlet ducts, and
a closing seat for each inlet and outlet duct comprising:
a sealing gasket having a first portion which is inserted into a housing defined in the wall of the inner recess wherein the ball is arranged and a second portion which protrudes from the housing and is in contact with the ball, and
a pressure element which pushes the sealing gasket against the ball, wherein the pressure element is arranged in the housing of the wall of the inner recess wherein the ball is arranged in contact with the first portion of the sealing gasket.

2. The ball valve with a cryogenic seat, according to claim 1, wherein the first portion of the sealing gasket has an annular lip which is retained in the housing by the pressure exerted by the pressure element.

3. The ball valve with a cryogenic seat, according to claim 1 wherein the pressure element is a hollow toroidal spring.

4. The ball valve with a cryogenic seat, according to claim 1, further comprising a channel which connects the inner recess of the valve to the housing.
